(19) United States
(12) Patent Application Publication
(10) Pub. No.: US 2015/0169587 A1
(43) Pub. Date: Jun. 18, 2015

(54) IDENTIFYING TRENDING CONTENT ON A SOCIAL NETWORKING PLATFORM

(71) Applicant: Openpage Labs Inc. d/b/a CrowdTangle, Baltimore, MD (US)

(72) Inventors: Brandon Ashley Silverman, Baltimore, MD (US); Matthew Noce Murphy Garmur, Oakland, CA (US)

(21) Appl. No.: 14/564,903

(22) Filed: Dec. 9, 2014

Related U.S. Application Data
(60) Provisional application No. 61/915,687, filed on Dec. 13, 2013.

(51) Int. Cl. G06F 17/30; H04L 29/06

(52) U.S. Cl. CPC G06F 17/3053; G06F 17/30551; H04L 65/403

(57) ABSTRACT

Disclosed are methods, systems, and computer-readable media for obtaining, at a server, a post from a source on a social networking platform, the posting comprising content, a content type, and a time stamp, determining, for the post, an engagement metric during each of a predetermined set of time periods, generating, at the server, a representative engagement metric for a particular time period selected from the predetermined set of time periods, the representative engagement metric being based on the engagement metric of the post during the particular time period, obtaining, at the server, a selected post from the source on the social networking platform, and transmitting, from the server, a score corresponding to a relative performance of the selected post compared to the representative engagement metric.

### CROSS-REFERENCE TO RELATED APPLICATION

This application claims the benefit of U.S. Provisional Application Ser. No. 61/915,687, filed on Dec. 13, 2013, which is incorporated by reference.

### BACKGROUND

An electronic social networking platform may store data about or otherwise related to interactions by users of the social networking platform with electronic message posts generated within the electronic social networking platform.

### SUMMARY

In general, one aspect of the subject matter described in this specification may include a method whereby a post from a source on a social networking platform is obtained at a server, each post including content, a content type, and a time stamp. An engagement metric during each of a predetermined set of time periods is determined for each post, a representative engagement metric for a particular time period selected from the predetermined set of time periods is generated at the server, the representative engagement metric being based on the engagement metrics of the post during the particular time period. A selected post from the source on the social networking platform is obtained at the server. A score corresponding to a relative performance of the selected post compared to the representative engagement metric is transmitted from the server.

Implementations can include one or more of the following features. For example, the content type may include one selected from the group including images, hyperlinks, messages, videos. An engagement metric determined for each post during each of the predetermined set of time periods may include determining of one or more of a number of likes, a number of shares, and a number of comments during each of a predetermined set of time periods.

Obtaining the post from the source on the social networking platform may include obtaining a plurality of posts from the source on the social networking platform, each of the posts including content, a content type, and a time stamp. Likewise, determining an engagement metric during each of a predetermined set of time periods for the post may include determining an engagement metric during each of a predetermined set of time periods for the plurality of posts. Also, generating the representative engagement metric for the particular time period selected from the predetermined set of time periods may include generating the representative engagement metric for the particular time period selected from the predetermined set of time periods, the representative engagement metric being based on the engagement metrics of the plurality of posts during the particular time period.

The representative engagement metric may include an average engagement metric. The representative engagement metric may include a weighted average engagement metric.

A set of weights for one or more of likes, shares, and comments may be received by the server, and a weighted average representative engagement metric may be generated at the server for the particular time period selected from the predetermined set of time periods, the weighted average representative engagement metric being based on the engagement metrics of the plurality of posts during the particular time period and the set of weights for one or more of likes, shares, and comments. The source may include a page on the social networking platform. The score corresponding to the relative performance of the selected post compared to the representative engagement metric may be determined to satisfy a predetermined threshold, and an alert identifying the selected post may be transmitted from the server. Obtaining a selected post from the source on the social networking platform at the server may include receiving a new post from the source on the social networking platform at the server.

Generating the representative engagement metric for a particular time period selected from the predetermined set of time periods at the server, the representative engagement metric being based on the engagement metrics of the plurality of posts during the particular time period may include generating a representative engagement metric for a particular content type and a particular time period selected from the predetermined set of time periods at the server, the representative engagement for the particular content type and the particular time period metric being based on the engagement metrics of the plurality of posts during the particular time period.

Generating the representative engagement metric for a particular time period selected from the predetermined set of time periods, the representative engagement metric being based on the engagement metrics of the plurality of posts during the particular time period may include generating, at the server, a representative engagement metric for each time period from the predetermined set of time periods, the representative engagement metrics being based on the engagement metrics of the plurality of posts during each respective time period.

Other features may include corresponding systems, apparatus, and computer programs encoded on computer storage devices configured to perform the foregoing actions.

The details of one or more implementations are set forth in the accompanying drawings and the description, below. Other features will be apparent from the description and drawings, and from the claims.

### BRIEF DESCRIPTION OF THE DRAWINGS

FIG. 1 shows an example of a system that provides communications among an electronic social networking platform, a social post analysis application, and various computing devices.

FIG. 2 is a schematic diagram of an example of electronic social networking platforms.

FIG. 3 is a diagram of examples of graphical user interfaces (GUIs) for an example of an electronic social networking platform.

FIG. 4 illustrates an example process for categorizing places in a social networking platform.

FIG. 5 is a diagram of an example of a GUI for an example of a social post analysis application.

FIGS. 6A and 6B are diagrams of an example of GUIs for example settings menus of a social post analysis application.

FIG. 7 is a diagram of an example electronic message post performance summary report.

FIGS. 8A and 8B are diagrams of example GUIs for example social network page management menus of a social post analysis application.

### DETAILED DESCRIPTION

Social networking and social network message posts have become a significant medium for individuals and organizations to disseminate information. However, due to the sheer number of social network posts generated each day it can be difficult for a social network user to gauge the performance of their social network posts and overall social networking communication strategy. A social post analysis application designed to analyze and track the performance of electronic message posts on various social network pages may allow social network users to effectively gauge the performance of their social network communication strategy and the overall efficacy of content being generated from a wide array of other sources on that social network. A social post analysis application may analyze electronic message posts generated on social network pages within an electronic social networking platform and generate performance scores based on the average of various social network user interactions with electronic message posts from each page. The social post analysis application may permit a user to readily search & gauge the effectiveness of their own electronic message posts, as well as posts coming from competitors, industry leaders and other relevant accounts, and in the process more easily follow and adapt to social network trends as they occur. A social post analysis application may also provide an interface and customizable email system that makes it easy to identify trends and effective content, and to perform broader analysis of the overall performance on a social network by a wide array of sources. The social post analysis application may be implemented on a computing system and allow users to access a web based interface through a user account or as an application installed on a user's computing device.

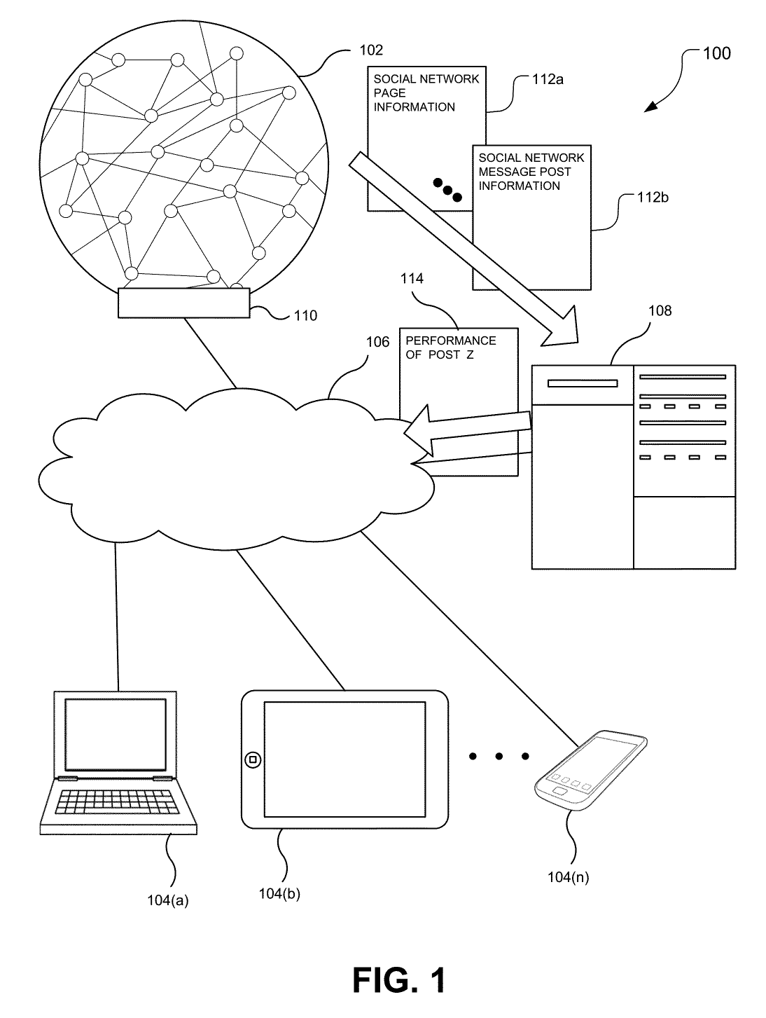

FIG. 1 shows an example of a system 100 that provides communications among an electronic social networking platform, a social post analysis application, and various computing devices. For illustrative purposes, several elements illustrated in FIG. 1 and described below are represented as monolithic entities. However, these elements each may include and/or be implemented on numerous interconnected computing devices and other components that are designed to perform a set of specified operations.

As illustrated in FIG. 1, system 100 includes an electronic social networking platform 102 that is accessible to a number of computing devices 104(a)-104(n), including, for example, a laptop computer 104(a), a tablet computer 104(b), and a smartphone 104(n), over a network 106. In addition, system 100 also includes a computing system 108 that hosts a social post analysis application. Computing system 108 may be external to electronic social networking platform 102. As such, electronic social networking platform 102 may be accessible to computing system 108 over network 106. Alternatively or additionally, in some implementations the social post analysis application may be hosted by the electronic social networking platform 102. Additionally, computing system 108 may be accessible to computing devices 104(a)-104(n) over network 106. User access to the social post analysis application may be through a web based interface or a separate user social post analysis application installed on a user's computing device 104(a)-104(n).

Electronic social networking platform 102 may be implemented using one or more computing devices (e.g., servers) configured to provide a service to one or more client devices (e.g., computing devices 104(a)-104(n)) connected to electronic social networking platform 102 over network 106. The one or more computing devices on which electronic social networking platform 102 is implemented may have internal or external storage components storing data and programs such as an operating system and one or more application programs. The one or more application programs may be implemented as instructions that are stored in the storage components and that, when executed, cause the one or more computing devices to provide the features of an electronic social networking platform 102. Furthermore, the one or more computing devices on which electronic social networking platform 102 is implemented each may include one or more processors for executing instructions stored in storage and/or received from one or more other electronic devices, for example over network 106. In addition, these computing devices also typically may include network interfaces and communication devices for sending and receiving data. Electronic social networking platform 102 also may provide an application programming interface (API) 110 that enables other applications to interact with and receive data from the electronic social networking platform 102.

Computing devices 104(a)-104(n) may be any of a number of different types of computing devices including, for example, mobile phones; smartphones; personal digital assistants; laptop, tablet, and netbook computers; and desktop computers including personal computers, special purpose computers, general purpose computers, and/or combinations of special purpose and general purpose computers. Each of the computing devices 104(a)-104(n) typically may have internal or external storage components for storing data and programs such as an operating system and one or more application programs. In particular, the internal or external storage components for each of the computing devices 104(a)-104(n) may store a client application for interfacing with electronic social networking platform 102 and/or a client application for interfacing with computing system 108. Additionally or alternatively, computing devices 104(a)-104(n) may be configured to interface with electronic social networking platform 102 or computing system 108 without a specific client application, using, for example, a web browser.

Each of the computing devices 104(a)-104(n) also typically may include a central processing unit (CPU) for executing instructions stored in storage and/or received from one or more other electronic devices, for example over network 106. Each of the computing devices 104(a)-104(n) also usually may include one or more communication devices for sending and receiving data. One example of such communications devices is a modem. Other examples include antennas, transceivers, communications cards, and other network adapters capable of transmitting and receiving data over a network (e.g., network 106) through a wired or wireless data pathway.

Network 106 may provide direct or indirect communication links between electronic social networking platform 102, computing devices 104(a)-104(n), and computing system 108. Examples of network 106 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data.

Computing system 108 hosts a social post analysis application. As such, computing system 108 is configured to receive and process data from one or more electronic social networking platforms (e.g., electronic social networking platform 102). For example, computing system 108 may be configured to exploit API 110 to receive data from electronic social networking platform 102. Among other features, computing system 108 may be configured to receive data about multiple different social network pages and electronic message posts generated by various users within the social network.

Computing system 108 may be implemented using one or more computing devices (e.g., servers). The one or more computing devices on which computing system 108 is implemented may have internal or external storage components storing data and programs such as an operating system and one or more application programs. The one or more application programs may be implemented as instructions that are stored in the storage components and that, when executed, cause the one or more computing devices to provide the features ascribed herein to the computing system 108. Furthermore, the one or more computing devices on which computing system 108 is implemented each may include one or more processors for executing instructions stored in storage and/or received from one or more other electronic devices, for example, over network 106. In addition, these computing devices also typically may include network interfaces and communication devices for sending and receiving data.

In some implementations, electronic social networking platform 102 may grant computer system 108 access to extract or receive information 112a related to individual social network pages within the electronic social networking platform 102 through API 110. Computing system 108 may extract or receive information related to pages within the electronic social networking platform such as, for example, electronic messages posts (e.g., posts, tweets, YouTube videos) generated on the page by a user associated with the page or another user. The information also may include information 112b related to interactions with the electronic message posts by other users within the electronic social networking platform such as, for example, endorsements of the electronic messages, comments related to the electronic messages, or actions associated with the electronic message posts (e.g., comments, endorsements, likes, shares, retweets, video views, hyperlink clicks, reblogs check-ins, etc.). A social post analysis application on computer system 108 may analyze the extracted or received information to identify trending user content within the electronic social networking platform. User content may include images, hyperlinks, messages, videos, and/or advertisements associated with pages or with electronic messages within the electronic social networking platform.

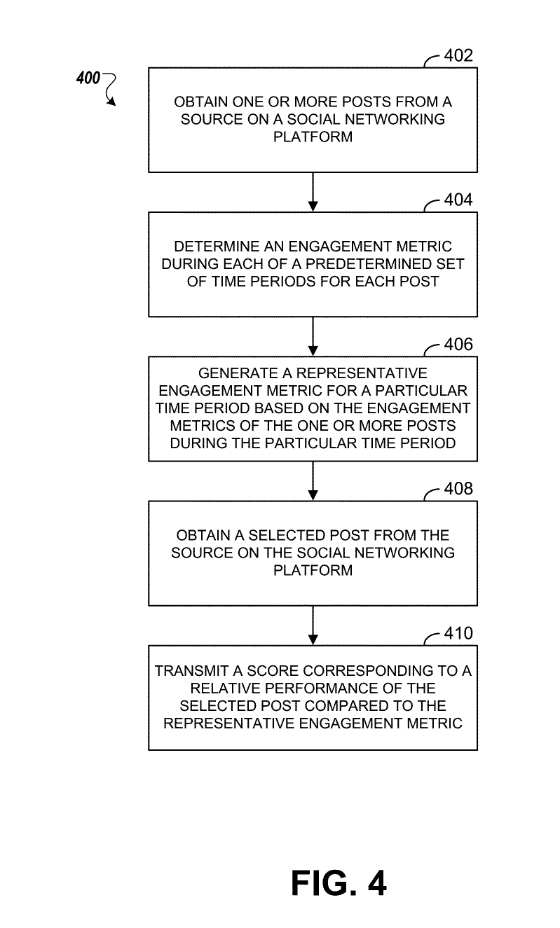

As described in more detail below in connection with FIG. 4, after receiving information from electronic social networking platform 102, computing system 108 may generate engagement metrics associated with individual electronic message and/or content posts for a user to gauge the effectiveness of the posts. In addition, the computing system 108 may generate a representative engagement metric to serve as a baseline for comparing to the engagement metrics associated with individual electronic message and/or content posts. The computing system 108 may then calculate a trending score for individual posts based on a comparison between an engagement metric associated with the post and the representative engagement metric. In some implementations, representative engagement metrics may be generated that measure the effectiveness of individual posts based on time, content type (e.g., images, hyperlinks, messages, videos, and/or advertisements), categories (e.g., news, politics, sports, education, entertainment, etc.), or other unspecified factors, or a combination of any of time, content type, categories or other factors. In some implementations, a relative engagement metric may be an average value of engagement metrics associated with posts on a particular page, account, or channel within the electronic social networking platform. In such an implementation a trending score calculated for a particular post may represent the effectiveness of the particular post relative to the average post on the particular page, account or channel.

Users of the social post analysis application may utilize various different computing devices (e.g., computing devices 104(a)-104(n)) communicatively coupled to computing system 108 via network 106 to access social network post trend data 114 calculated by the social post analysis application. In addition to providing individual users with access to the processed data, computing system 108 also may provide these individual users with various analysis and reporting tools for manipulating the social network post trend data included within the social post analysis application categories. In some implementations, access to the social post analysis application through computing system 108 may be provided via a web based interface and/or a social post analysis application user account. Additionally or alternatively, such analysis and reporting tools may be provided within a client application resident on a computing device that an individual user can utilize to access the processed data made available by computing system 108.

Among other reporting and analysis tools, computing system 108 (and/or the client application used to access computing system 108) may provide the users with filtering tools that enable the user to identify post trend data based on comparison with different representative engagement metrics (e.g., based on time, content type, category, or any combination of the three).

A social post analysis application that provides individual users of an electronic social networking platform with access to post trend data as described above and/or that provides the individual users with reporting and analysis tools for manipulating such received and processed data may enable the individual users to glean a better understanding of social trends from interactions by social network users with various posts within the electronic social networking platform. In some implementations, the social post analysis application may enable individual users to analyze and/or compare post trend data across multiple electronic social networking platforms.

There are many different examples of electronic social networking platforms. Facebook, Twitter, LinkedIn, Google+, MySpace, YouTube, and Orkut are just a few examples. But, there are many others, and it is reasonable to expect many more to be developed in the future. Techniques are described herein for receiving, analyzing, and/or acting upon data from an electronic social networking platform. These techniques are widely applicable and may be employed in connection with any of, or a subset of, the above electronic social networking platforms or any other electronic social networking platforms. In addition, various ways in which social network users may interact with electronic message posts are described herein (e.g., comments, endorsements, likes, shares, retweets, reblogs, video views, hyperlink clicks, check-ins, etc.), however, it is reasonable to expect that new methods will develop or new terms will be applied to similar actions. The social network electronic message post analysis techniques described herein may be equally applicable to any newly developed user interactions.

Electronic social networking platforms often enable an individual user to create a social network page that reflects various different types of information about or otherwise related to the user. Users may represent a human user or an organization. The social network page may describe general details about the user associated with the page, for example, a profile of the human user or organization associated with the page and/or a brief description of the content provided on the page. For instance, a Facebook or LinkedIn page may describe details of a specific user such as the user's hometown, interests and hobbies, education, and/or work experience. Similarly, a YouTube page (e.g., channel) may describe the general content of videos. In addition, a social network page provides a portal for users to broadcast various content posts (generally referred to in this document as electronic message posts) including, for example, images, hyperlinks, messages, video, and/or advertisements. Other social network users may be able to interact with electronic message posts, for example, by endorsing (e.g., liking) a post, sharing a post with other users, commenting on the post, viewing a video in the post, or clicking a hyperlink in the post. Any or all of these or other interactions with the post by social network users may serve as a proxy for the popularity of the post and be useful in estimating the effectiveness of a post.

Electronic social networking platforms also typically enable an individual user (e.g., representing a human user who has registered with the electronic social networking platform and/or an organizational user) to establish connections with other users. (Social network “connections,” as referred to in this document, include subscriptions and other means of associating a particular user with another user or a page associated with another user within an electronic social networking platform.) These connections between users may reflect relationships between the underlying human users of the electronic social networking platform who are represented by the users. For example, a connection between two users within an electronic social networking platform may reflect a social friendship (e.g., developed through physical interaction in the real-world and/or through on-line interaction in the cyber-world), a professional relationship between the underlying human users represented by the users, or a subscription to a social networking page.

The connections between individual users within an electronic social networking platform may be represented in the form of a graph, where users are represented by nodes and connections between users are represented by edges connecting the nodes. As new users join and other users stop using the electronic social networking platform and/or as new connections between users are formed and old connections between users are dissolved, this graph of interconnected users may change dynamically in time to represent the current state of connections between users within the electronic social networking platform.

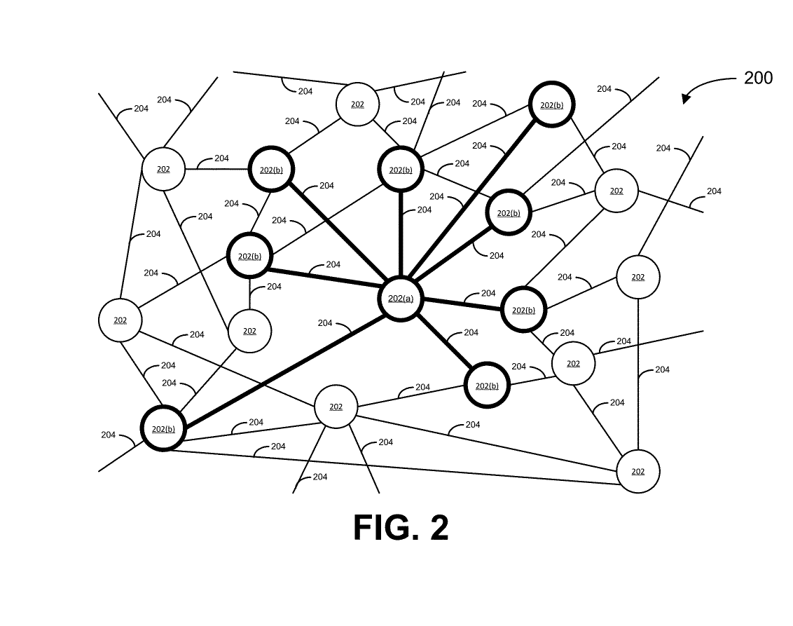

FIG. 2 is a schematic diagram of an example of an electronic social networking platform. As illustrated in FIG. 2, the electronic social networking platform is represented as a graph 200 of nodes 202 connected by edges 204. In some implementations, each node 202 of graph 200 may represent an individual user of the electronic social networking platform. In such implementations, an edge 204 that connects two nodes 202 represents a connection that has been formed between the two users that are represented by the connected nodes 202. For example, the edges 204 that connect node 202(a) to nodes 202(b) represent connections that have been formed within the electronic social networking platform between the user represented by node 202(a) and the other users represented by nodes 202(b).

As discussed above, in some cases, an electronic social networking platform may define a particular user's social network as the group of other users to whom the user is directly connected. If this definition is applied within the electronic social networking platform illustrated in FIG. 2, the social network for the user represented by node 202(a) would be defined as the group of other users represented by nodes 202(b).

As further discussed above, an electronic social networking application may facilitate the sharing of information and the exchange of electronic communications between a particular user and other users who are members of the particular user's social network. For example, referring to the electronic social networking platform represented in FIG. 2, the electronic social networking application may provide mechanisms that facilitate the exchange of electronic communications between the user represented by node 202(a) and the users represented by nodes 202(b) who are part of the social network of the user represented by node 202(a). In some implementations, the electronic social networking application may provide a mechanism that enables the user represented by node 202(a) to send private electronic messages to any of one or more of the users represented by nodes 202(a). Furthermore, the electronic social networking application also may provide a mechanism that enables the user represented by node 202(a) to broadcast an electronic message (e.g., a post or a comment) that is shared publicly with all (or some defined subset of all, such as, for example, one or more “Friendlists”) of the users represented by nodes 202(b). For example, a post message may include an electronic message initially broadcast by a user, while a comment message may include an electronic message generated by a user in response to and associated with a prior electronic message (either a post or another comment) broadcasted by the user or another user.

Social networking platforms may allow users to generate various electronic message posts including, for example, images, hyperlinks, messages, video, and/or advertisements. The social network platforms may allow users to generate the electronic message posts on a page associated with the user or on pages associated with other users. Furthermore, the social networking platforms may allow users to interact with electronic message posts generated by other users, for example, by endorsing (e.g., “liking”) a post, sharing a post with other users, commenting on the post, viewing a video in the post, or clicking a hyperlink in the post.

In addition to enabling users to establish connections to other users and generate message posts, some electronic social networking platforms enable users to establish connections with other types of objects. For example, some social networking platforms may enable users to record information about their hometowns, current places of residence, or places they have visited, including geographic locations (e.g., such as cities, states, or countries), as well as commercial venues, local businesses, or places (e.g., such as restaurants, retail stores, parks, train or bus stations, airports, etc.)) by establishing connections to location objects within the electronic social networking platforms. In some cases, a user may be said to record a check-in with an electronic social networking platform when the user records information within the electronic social networking platform about a location the user has visited. Some electronic social networking platforms also may enable users to record check-ins on behalf of other users. For instance, some electronic social networking platforms may enable members of a particular user's social network to record a check-in on behalf of the particular user (e.g., when the users visit a location together). In such scenarios, the electronic social networking platform may record the location as a location the particular user visited even though the check-in at the location was not initiated by the particular user.

Additionally or alternatively, an event object within an electronic social networking platform also may be manifested as an “event page” that provides information about the event the object represents (e.g., date, time, and location information for the event), and the electronic networking platform may enable one or more designated representatives associated with the event (e.g., the hosts) to share information and exchange electronic communications with users who have been invited to the event via the “event page.”

Similarly, some social networking platforms may enable users to record endorsements of various different types of interests, for example, by establishing connections to interest objects that represent these interests. Such interest objects may include a variety of different types of objects including, for example, local businesses or places (e.g., restaurants, retail stores, parks, train or bus stations, airports, etc.); companies, organizations, or institutions; brands or products; artists, bands, or public figures; forms of entertainment (e.g., books, music albums, movies, etc.); and causes or communities. In some electronic social networking platforms, interest objects may be manifested within the electronic social networking platforms as so-called “pages.” These pages may be maintained by one or more representatives of the interests represented by the objects. In addition, among other features, these pages may provide information about the interests represented by the objects. These pages also may provide conduits for enabling interaction between the interest objects and the users that have formed connections to the objects that represent them. Furthermore, some electronic social networking platforms may enable pages, similarly to users, to establish event objects related to events associated with the interest represented by the page.

Some electronic social networking platforms provide mechanisms that enable independent applications to leverage the electronic social networking platforms to provide services to client computing devices that are in addition to the services provided by the electronic social networking platforms themselves. One example of such an independent application is a social post analysis application. A social post analysis application may receive information related to individual social network pages and electronic message posts from the electronic social networking platform.

For example, as described in greater detail below, a social post analysis application may receive data related to electronic message posts, such as data related to interactions with the electronic message posts by other users (e.g., endorsements, comments, shares, views, hyperlink selections, etc.), and may generate one or more engagement metrics for the post based on the data. For example, the social post analysis application may generate an engagement metric for an electronic message post based on a weighted sum of the number of each type of interaction with the electronic message post. For instance, an electronic message post engagement metric may be calculated according to Equation 1 below:

engagement metric=Σᵢ₌₁^{M}n_{interaction type}_{ᵢ}·wᵢ (Eq. 1)

where n_{interaction type i} is the number of user interactions of a given type with the electronic message post and wᵢ is a weighting assigned to the given interaction type. In some implementation the value of each weighting may be user defined. In some implementations, the social post analysis application may generate a series of engagement metrics for a single electronic message post across series of time steps or a set of time periods. For example, a trend of interactions with electronic message posts within a social network tends to vary with time from the initial generation of the post.

Similarly, for example, the social post analysis application also may generate a representative engagement metric to provide a performance baseline for evaluating individual electronic message posts. For example, the representative engagement metric may be an average of the engagement metrics for all electronic message posts generated on a given social network page within each time step or time period. Alternatively, the representative engagement metric may be a weighted average of the engagement metrics for all electronic message posts generated on a given social network page within each time step or time period. In some implementations, a separate representative engagement metric may be generated based on different types of content in electronic message posts (e.g., images, video, hyperlinks, etc.) or based on different categories of electronic message posts (e.g., news, politics, education, sports, etc.). In so doing, the performance of a particular electronic message post may be compared against that of other similar electronic message posts. To provide a useful comparison, the social post analysis application may calculate a trend or performance score for electronic message posts based on a comparison of an engagement metric with a particular representative engagement metric.

The different examples of electronic social networking platforms described above may provide various different types of user interfaces for interacting with the electronic social networking platforms. In one particular example, an electronic social networking platform may provide multiple different GUIs to a user to enable the user to interact with the underlying electronic social networking platform.

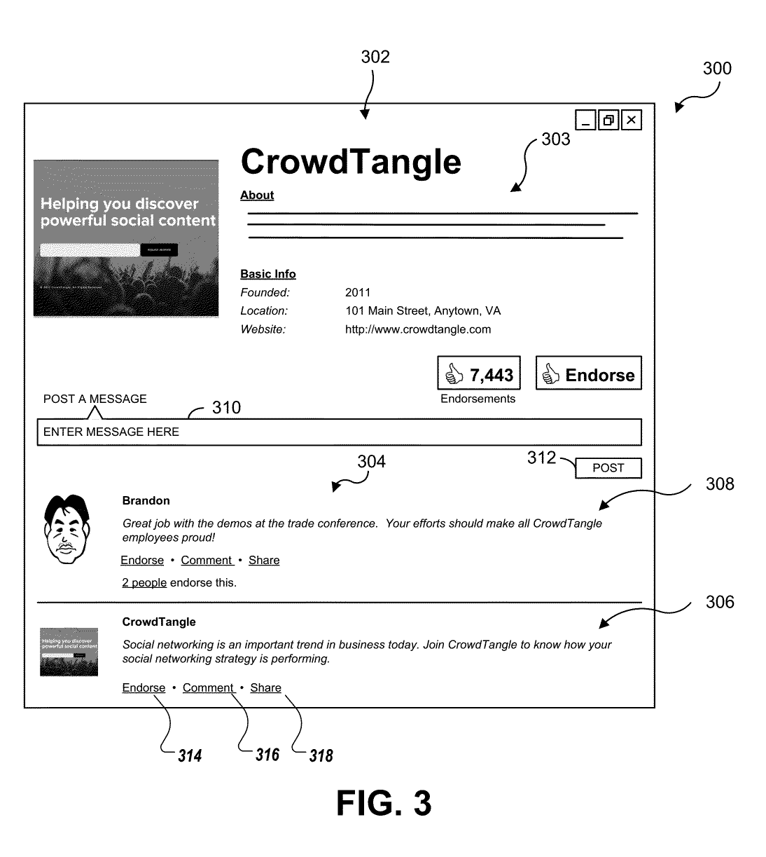

As discussed above, in some electronic social networking platforms, interests may be represented as interest objects that are manifested within the electronic social networking platform as pages. FIG. 3 is a diagram of an example of a graphical user interface (GUI) 300 for an example of an electronic social networking platform page. More particularly, GUI 300 displays the CrowdTangle social networking platform page 302 corresponding to the CrowdTangle interest object that represents the software and technology company, CrowdTangle, within the electronic social networking platform.

As illustrated in FIG. 3, the CrowdTangle page 302 includes a description section 303 that provides background information about CrowdTangle. The CrowdTangle page 302 also includes a feed 304 that includes, among other content, electronic message posts 306 generated by the CrowdTangle page 302 and published to users of the electronic social networking platform who have endorsed the CrowdTangle page 302 or otherwise established a connection to the CrowdTangle page 302 within the electronic social networking platform. In addition, as further illustrated in FIG. 3, the feed 304 also includes electronic message posts 308 posted directly to the CrowdTangle page 302 by users of the electronic social networking platform. The electronic social networking platform may provide a variety of different mechanisms that enable users of the electronic social networking platform to post messages directly to a page, such as, for example, the CrowdTangle page 302. In one example, the electronic social networking platform may enable a user to post a message directly to the CrowdTangle page 302 by entering text in text entry field 310 and invoking selectable “Post” control 312. Although not illustrated as such in FIG. 3, feed 304 also may include various additional or alternative types of content.

The electronic message posts (306 and 208) on the CrowdTangle page 302 include selectable “Endorse” links 314 that enable users who view the CrowdTangle page 302 and the electronic message posts (306 or 308) to record an endorsement of the posts. In response to invocation of a selectable “Endorse” link 314 by a particular user, the electronic social networking platform records that the particular user has endorsed the applicable electronic message post, for example, by incrementing a number of endorsements that the post has received from users within the electronic social networking platform.

Likewise, the electronic message posts (306 and 208) on the CrowdTangle page 302 include selectable “Comment” links 316 that enable users who view the CrowdTangle page 302 and the electronic message posts (306 or 308) to record comments on the posts. In response to determining that a selectable “Comment” link 316 has been selected by a particular user, the electronic social networking platform displays a text box allowing the particular user to record a comment about the post. Along with the comment itself, the electronic social networking platform may record the number of comments recorded by users in response to each electronic message post (306 and 308).

In some electronic social networking platforms, electronic message posts generated by a particular user may be shared with or otherwise made available to other users of the electronic social networking platform. The electronic message posts (306 and 208) on the CrowdTangle page 302 include selectable “Share” links 318 that enable users to share the electronic message posts (306 and 208). In particular, in some electronic social networking platforms, interests endorsed by a particular user may be shared with other users who are members of the particular user's social network. For example, an electronic social networking platform may provide users who are members of a particular user's social network with access to a detailed user profile page that includes, among other information, indications of interests that the particular user has endorsed within the electronic social networking platform. In addition, the electronic social networking platform may record the number of times each post was shared by different users.

FIG. 4 illustrates an example process 400 for categorizing places in a social networking platform. The process 400 may be performed by a computing system, such as, for example, computing system 108 of FIG. 1.

The computing system obtains one or more posts from a source on a social networking platform (402). As described above, the computing system extracts information related to social network pages and electronic message posts through an electronic social networking platform API. In some implementations, the computing system may continuously query the electronic social networking platform API for updated data and extract updated information about previous social network page and electronic message posts and also newly generated social network pages and electronic message posts. The information related to electronic message posts includes the number and type of social network user interactions that may have taken place with the electronic message posts. For example, CrowdTangle may generate a new electronic message post announcing a new product feature. Other users (e.g., clients, prospective clients, friends, and/or tech journalists) may interact with the new product feature electronic message posts by endorsing the post, sharing the post, or commenting on the post. The computing system then extracts the number of endorsements (e.g., 2,375), shares (e.g., 398), and comments (e.g., 431) that the post received. In another example, the CrowdTangle new product feature electronic message post may include a video and a hyperlink. In this example, the computing system also may extract the number of times the video was viewed or the hyperlink was clicked.

Next, the computing system determines an engagement metric during each of a predetermined set of time periods for each post (404). For each post, the computing system segments the extracted post interaction data into a series of time periods (e.g., time steps) and calculates engagement metrics for the post during each time period. The engagement metrics for each post is a weighted sum of the number of each type of interaction with the electronic message post. For instance, an electronic message post engagement metric may be calculated according to Equation 1 below:

engagement metric=Σᵢ₌₁^{M}n_{interaction type}_{ᵢ}·wᵢ (Eq. 1)

where n_{interaction type i} is the number of user interactions of a given type with the electronic message post and wᵢ is a weighting assigned to the given interaction type. In some implementation the value of each weighting may be user defined. For example, assuming an endorsement weight of 1, a share weight of 3, and a comment weight of 2; an engagement metric for the exemplary CrowdTangle post would be:

engagement metric=2375(1)+398(3)+431(2)=4431

In some implementations the weights for each type of interaction may be user defined. In such implementations, the computer system may store the interaction data for each post, or a subset of posts, and recalculate engagement metrics as the user alters different weightings.

The time periods serve as a way of normalizing the electronic message post engagement data because interactions with social network electronic message posts tend to vary over time. For example, the interaction with a particular post will generally ramp up quickly to a maximum level and slowly die off as the post ages. Thus, in some implementations each of the time periods may represent unequal durations of time. For example, the first time period may account for interactions with a post occurring from the time the post was generated until 15 minutes later; the second time period may continue from 15 minutes until the post is 45 minutes old; the third time period may continue from 45 minutes until the post is 2 hours old; and so on. Each subsequent time period may be greater in length. In some implementations the time period steps size may be described by a mathematical formula (e.g., a geometric sequence). In other examples, different time periods may be used. For example, the first time period may account for interactions with a post occurring from the time the post was generated until 15 minutes later; the second time period may account for interactions with a post occurring from the time the post was generated until 45 minutes later; the third time period may account for interactions with a post occurring from the time the post was generated until 2 hours later; and so on. Each time period may be different in length and may or may not overlap in time with other time periods.

Then, the computing system generates a representative engagement metric for a particular time period based on the engagement metrics of the one or more posts during the particular time period (406). A representative engagement metric serves as a baseline for using each electronic message post's engagement metric to evaluate each post's performance. The computer system may generate various different representative engagements metric such that a user may evaluate the performance of electronic message posts relative to different baselines. Generally, the computing system will generate a representative engagement metric based on the engagement metrics of a plurality of electronic message posts generated on a particular social network page during each particular time period; a page representative engagement metric. The page representative engagement metric provides a baseline performance metric for any individual electronic message post generated on the particular social network page for which the page representative engagement metric was calculated.

The computing system may calculate representative engagement metrics by taking an average or weighted average of engagement metrics for all or some of the electronic message posts generated by a particular social network page. A representative engagement metric may be generated to provide a historical performance metric for posts on a particular page during each time period. Such a representative engagement metric may be a series of representative engagement metrics calculated for each predefined time period. For example, the representative engagement metric for the first time period may be an average or weighted average of the first time period engagement metrics for all or some of the electronic message posts historically generated on the particular page. In some implementations, such an engagement metric for a particular social network page is regularly updated to incorporate data from new electronic message posts.

In addition, the computing system also may generate representative engagement metrics for various categories of electronic message posts. For example, an electronic message posts may be classified by the electronic social networking platform or by a user as relating to news, politics, sports, entertainment, education, advertisements, etc. The computing system may generate particular representative engagement metrics related to posts in each category. For instance, a representative engagement metric for sports posts may be calculated as an average or weighted average of all or some of the engagement metrics for electronic message posts classified as being related to sports. As described above, such a representative engagement metric may include a series of representative engagement metrics each calculated for each predefined time period. Likewise, representative engagement metrics may be generated which correspond to different types of electronic message post content (e.g., electronic message posts containing images, video, hyperlinks, etc.).

The computing system, then, obtains a selected post from the source on the social networking platform (408). Finally, the computing system transmits a score corresponding to a relative performance of the selected post compared to the representative engagement metric (410). The computing system will calculate a performance score for a particular electronic message post on a particular social network page by comparing an engagement metric for the particular post with a corresponding representative engagement metric of the social network page. The calculated performance score may be either qualitative or quantitative. For example, performance scores may include “overperforming” and “underperforming,” or other similar classifications describing whether the engagement metric of the particular electronic message post exceeds or falls below the corresponding representative engagement metric. In addition or alternatively, the performance score may be quantitative, for example, the performance score may indicate a percentage by which the engagement metric of the particular electronic message post exceeds or falls below the corresponding representative engagement metric. The corresponding representative engagement metric may, for example, be a representative engagement metric representing the same predefined time step or time period as that of the engagement metric for the particular electronic message post, a different time step or time period from that of the engagement metric for the particular electronic message post, or an average of two or more different time steps or time periods. In some implementations, the corresponding representative engagement metric may be one tailored to a particular electronic message post category or content type.

In some implementations, an alert may be generated when the engagement metric for a particular post exceeds a corresponding representative engagement metric by a predefined threshold value, thus alerting a user to a post that has become “viral.” A “viral” post may be one that has generated a number of social network user interactions that greatly exceeds the norm. The threshold value may be a user defined value in some implementations.

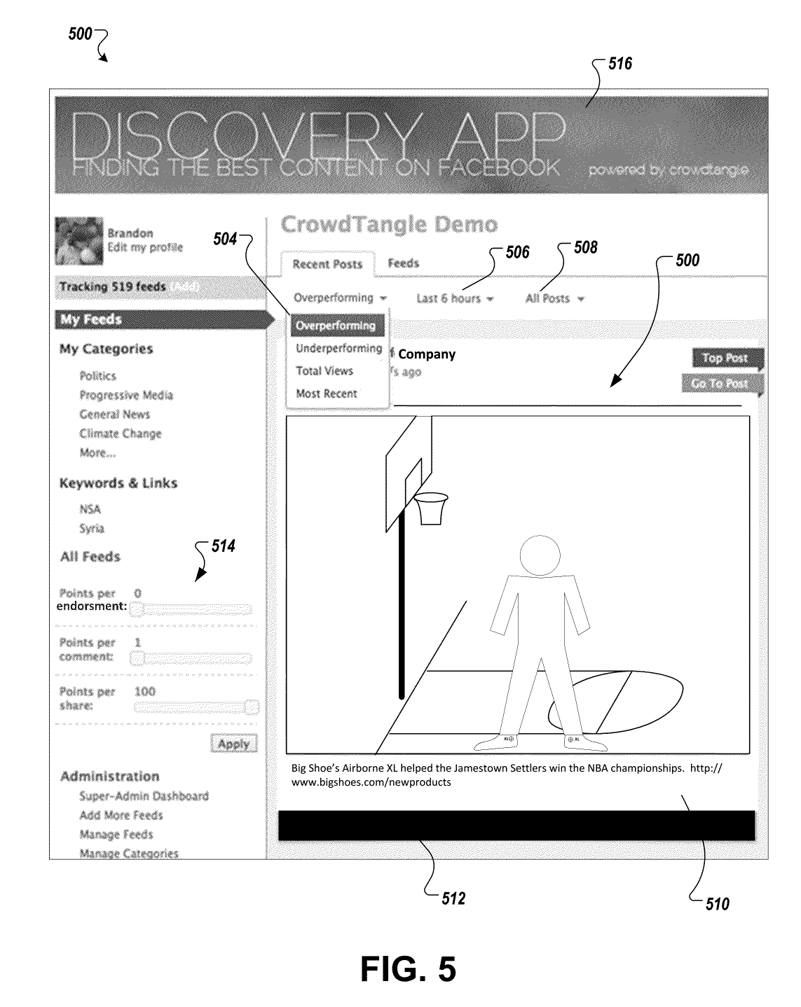

FIG. 5 is a diagram of an example of a GUI 500 for an example of a social post analysis application. The social post analysis application may be implemented as either an application installed on a user's computing device, as a web based application in which a user is provided access to the social post analysis application through a user account, or both. GUI 500 represents an example user interface appropriate for either implementation. GUI 500 includes an electronic message post feed 502, feed filter menus 504, 506, and 508, an example electronic message post 510, and an application header image 516. GUI 500 provides an interface for users to identify and select social networking pages to track, see and sort electronic message posts from the user selected social network pages, and to customize social post analysis application settings. The electronic message post feed 502 is a continuously updating display of electronic message posts from a user's selected social network pages. The electronic message post 510 is an example of an electronic message post containing an image and a hyper link to the website bigshoes.com. Just below the electronic message post 510, the social post analysis application displays post performance data bar 512 relate to social network user interaction with electronic message post 510. For instance, the performance score for electronic message post 510 shows that electronic message post 510 has an engagement metric 42.6 times greater than the representative engagement metric for the Big Shoes Company social network page. In other words, electronic message post 510 has generated 42.6 times more social network user interaction than the average electronic message post from the Big Shoes Company social network page, where the engagement metric is based on the number and type of interactions of users with the electronic metric post 510, and weights assigned to those types of interactions. In addition, the post performance data bar 512 may present detailed data related to individual social network user interaction types (e.g., the total number of endorsements, shares, comments, views, and/or clicked hyperlinks). For instance, the post performance bar 512 shows that electronic message post 510 has received 120 endorsements which is 94 more endorsements than the average Big Shoe Company electronic message post and 86 shares which is 84 more than the average Big Shoe Company emp.

Feed filter menus 504, 506 and 508 allows a user to filter and sort the electronic message posts that are displayed within the feed 502. For example, the feed filter menu 504 is a user selectable menu that allow a user to sort electronic message posts displayed within the feed 502 by their overall performance as measured by their performance score (e.g., overperforming or underperforming), by a particular interaction type (e.g., total views, total shares, total endorsements), or by time (e.g., most recently posted). Similarly, feed filter menu 506 is a user selectable menu that allows a user to filter the electronic message posts displayed within feed 502 by time period, such that the social post analysis application will only display posts that were available during a selected time period. In addition, in some implementations, the social post analysis application may only show performance scores for each displayed electronic message post that are based on user interactions with each electronic message post within the selected time period. For example, as illustrated, “Last 6 hours” is selected for feed filter menu 506. Therefore, in such implementations the post performance data 512 displayed in conjunction with electronic message post 510 represents only the endorsements, shares, and comments that electronic message post 501 received during the last 6 hours. Also, in like manner, feed filter menu 508 is a user selectable menu that allows a user to filter the electronic message posts displayed within feed 502 by category or content (e.g., politics, news, entertainment, image posts, video posts, hyperlink posts, etc.). Upon receiving a user's selection of one of the options in any of feed filter menus 504, 506, or 508 the social post analysis application will sort or filter the electronic message posts within the feed 502 appropriately.

As described above, in some implementations a user may be permitted to define the weighting values used to calculate electronic message post engagement metrics and the page representative engagement metrics. The slider bar inputs 514 illustrate an exemplary method by which the social post analysis application may receive user defined weightings. For instance, as illustrated, a particular user may consider share interactions with electronic message posts to be more relevant to evaluating electronic message post performance than comments or endorsements, and therefore, may select a greater weight for share interactions.

Finally, some implementations include a uniform resource locator (URL) search feature, for example a URL text search box in GUI 500. The URL search feature allows a user to input a URL into a search box in GUI 500. Once the social post analysis application receives a URL, the social post analysis application may search the electronic social network for electronic message posts that include the URL. The social post analysis application may then determine and display statistics related to the search, for example, the number of electronic posts that include the URL, the number of different social network pages from which electronic posts that include the URL were generated, and/or a list of the different social network pages from which electronic posts that include the URL were generated. For instance, a blog editor may want to know which social network pages are driving web-traffic to the editor's blog. The editor could perform a URL search using the URL of this blog in GUI 500 and the social post analysis application would display the social network statistics related to electronic message posts that included the blog's URL.

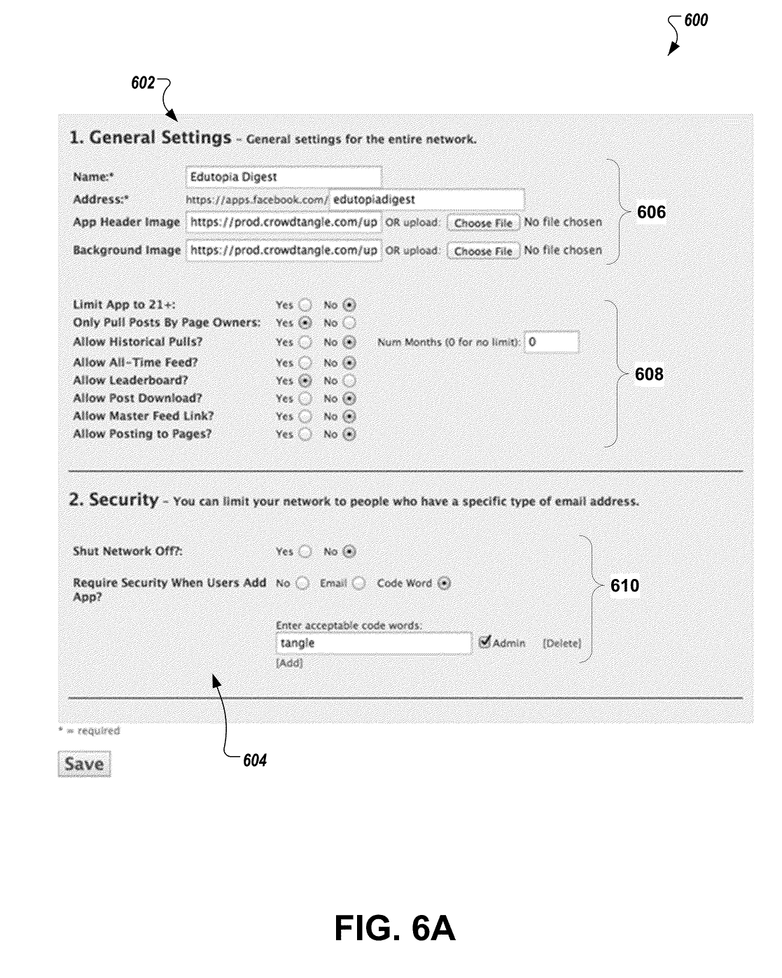

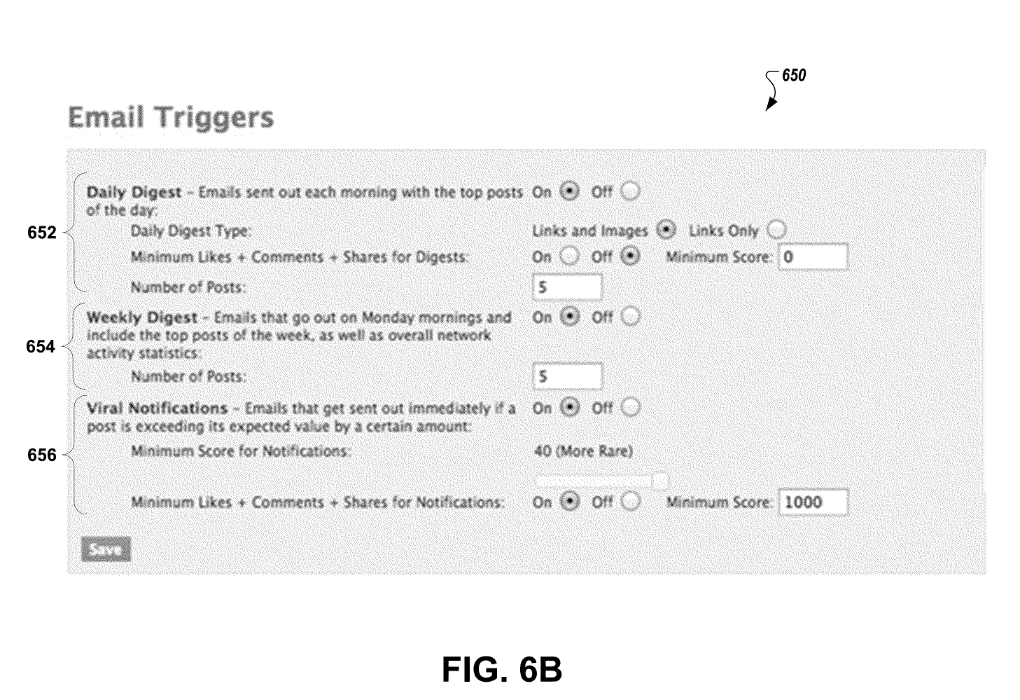

FIGS. 6A and 6B are diagrams of an example of GUIs 600 and 650 for example settings menus of a social post analysis application. FIG. 6A illustrates an example GUI 650 that allows a user to customize various general settings within the social post analysis application. GUI 600 includes a general settings section 602 and a security settings section 604. The general settings section 602 includes a set of user editable text boxes 606 which allow a user to customize a name of their social post analysis application, a URL for their social post analysis application (e.g., for an exemplary social post analysis application of a web based implementation), an application header image, and a background image. The application header image is an image that shows up at the top of GUI 500. The social post analysis application may allow users to either add a direct link to an image or upload an image from their computing device for both an application header image and a background image.

In addition, the general settings section 602 includes a set of user selectable radio buttons (or other appropriate inputs) which allow a user to customize various functions of the social post analysis application. For example, the Limit App to 21+ setting allows a user to provide or restrict access through their social post analysis application to social network pages that can only display their content to social network user profiles that are over 21 years of age (e.g., pages for alcohol brands). For instance, if a user chooses to limit access to their social post analysis application to users that are over 21 years of age, the social post analysis application will be permitted to access electronic message posts from social network pages with restricted content (e.g., pages for alcohol brands). The Only Pull Posts by Page Owners setting allows a user to select whether the user want the social post analysis application to analyze electronic message posts authored only by owners of the social network pages that they have selected to track, or whether they want the social post analysis application to analyze electronic message posts authored by both page owners and other social network users. For example, the user of GUI 500 in FIG. 5 has selected to monitor electronic message posts from the Big Shoe Company social network page. If the user selects to analyze electronic message posts authored only by the owner of the Big Shoe Company site, the social post analysis application will only provide performance data for electronic message posts generated by the Big Shoe Company user and will ignore electronic message posts generated on the Big Shoe Company social network page by other users. The setting Allow Historical Pulls allows a user to select whether the social post analysis application downloads the post history of the social network pages that the user has selected to track. The Allow Historical Pulls setting toggles this feature on or off for and permits the user to enter a timeframe of historical electronic message posts to download (e.g., 4 months of historical electronic message posts). The Allow All-Time Feed setting allows a user to cycle on and off the time filter 506 of FIG. 5.

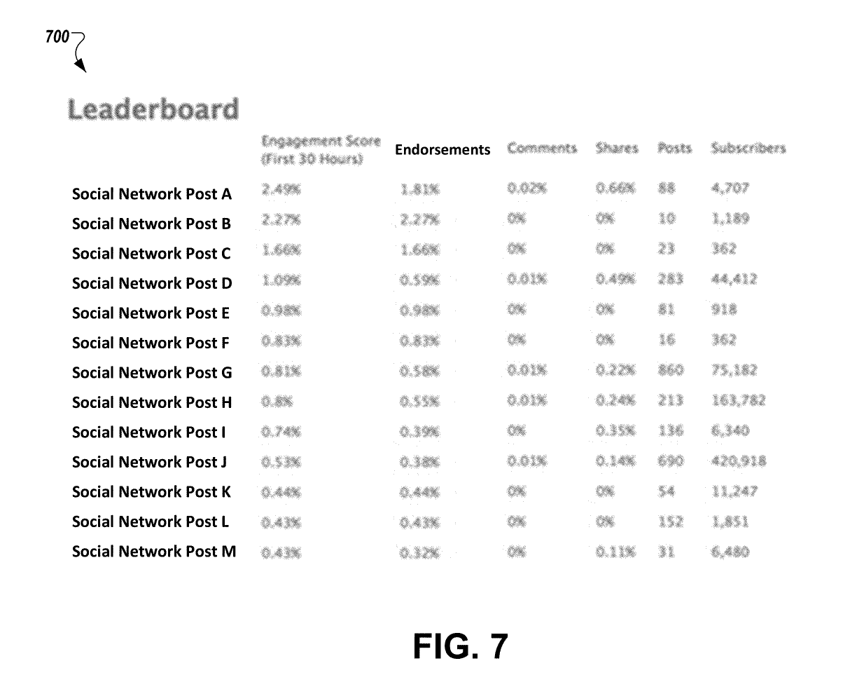

The Allow Leaderboard setting allows a user to cycle on or off a leaderboard feature. Referring to FIG. 7, FIG. 7 is a diagram of an example electronic message post performance summary report 700 (e.g., a leaderboard). The social post analysis application may display an electronic message post performance report of the average performance of all the social network pages a user is tracking. The performance summary report 700 may be customized to rank the social network pages based on overall performance score or based on a single type of user interaction (e.g., based on endorsements, comments, shares, etc.). The performance summary report 700 also may be adjusted to show the scores based on a variety of different time periods, for example, the last day, the last three days, the last week, the last month, the last year, or all-time.

The setting Allow Post Download allows a user to select whether the social post analysis application downloads and stores all the electronic message post information extracted from the electronic social networking platform. The Allow Master Feed Link setting cycles on and off a link on GUI 500 to an electronic message post feed that displays overperforming electronic message posts from every social network page tracked in an social post analysis application system (e.g., computing system 108). In some implementations, the social post analysis application may automatically repost electronic message posts to a user's own social network page if an electronic message post from a social network page that the user is tracking exceeds a predefined threshold value. For example, if a user set an overperformance threshold value for automatic posting at 40 times the social network page average (e.g., the representative engagement metric) then the Big Shoe Company electronic message post 510 would be automatically reposted to the user's own social network page. The Allow Posting to Pages setting allows a user to cycle on or off this automatic reposting feature. In some implementations, the social post analysis application may allow a user to select a predefined overperforming threshold value, for example, using a dropdown menu or a text box. In addition, the automatic reposting feature may provide a user with the option to have a preset number of comments associated with automatically reposted electronic message posts included on the user's own social network page with the reposted electronic message post.

In some web based implementations, a user may be allowed to provide other social network users with the ability to view or access the user's social post analysis application account. In such an implementation other users may be able to view GUI 500 of the user's social post analysis application account, for example, by visiting the user specified URL in setting section 604. The security settings section 604 allows the user to customize settings related to such an account sharing feature. The Shut Network Off setting restricts public access to a user's web based social post analysis application account such that only the user who owns the account may access GUI 500. The Require Security When Users Add setting allows a user to define a security password when other social network users access the user's social post analysis application account.

FIG. 6B illustrates an example GUI 650 that allows a user to customize various e-mail alerts within the social post analysis application. In some implementations, the social post analysis application may provide a user with various e-mail alerts or digests related to electronic message post activity tracked by the user's social post analysis application. GUI 650 includes customizable settings related to Daily Digest e-mails 652, Weekly Digest e-mails 654, and Viral Notification e-mails 656. Daily Digest e-mails are daily e-mails sent by the social post analysis application to a user that include any number of the top scoring electronic message posts from a user's selected social network pages. The Daily Digest e-mail may, for example, including the full post, a link to the post, and the post's performance scores. Weekly Digest e-mails, may be similar to the Daily Digest e-mails, but may be sent only once a week and also may include a section summarizing the overall performance statistics across all the social network pages tracked by the user. In some implementations, the Daily Digest and/or Weekly Digest e-mails may include a feature permitting a user to send an e-mail to a predefined group of other social network users or e-mail contacts including a copy of one or more of the electronic message posts from the digest e-mail and a comment provided by the user. In some implementations, the Digest e-mails may be sent at other time intervals, for example, monthly, bimonthly, and so on.

In addition, some implementations of the social post analysis application may send various other e-mails to users. For example, Viral Notification e-mails may be sent to indicate that a particular electronic message post has exceeded a predefined “viral” performance score threshold. Similarly, Keyword/Link Alert e-mails (not shown) may indicate that an electronic message post that includes a particular user defined keyword has been posted to a user tracked social network page. Also, Trend Alert e-mails (not shown) may inform a user about broad activity trends occurring among the social network pages that the user is tracking. For instance, if a particular category of social network pages (e.g., a user defined category or subset of social network pages) experiences an unusual jump in the overall social network user engagement of all or a substantial portion of electronic message posts on the pages, the social post analysis application will send a Trend Alert e-mail to alert the user to the activity.

User customizable options for any of the e-mails discussed above may include, for example:

| | |
|---|---|
| On or Off | Turns Daily Digest e-mails on or off |
| Email Type | Allows users to define what type of email notification |
| | they want, including immediate notifications (viral |
| | alerts or referral alerts) or scheduled digests (daily, |
| | weekly, monthly, etc.) |
| Name & | Users can give each email a name and a unique |
| Subject | subject line |
| Post Types | Allows users to set the type of posts to be included in |
| | the e-mails (e.g., videos, hyperlinks, images, text, etc.) |
| Minimum | Allows users to filter posts to limit posts included in the |
| | e-mails to those with a minimum defined performance |
| | score |
| Number of | Allows users to set a maximum number of posts to be |
| Posts | included in the e-mails |
| Keywords | Allows users to limit e-mails to posts that only have |
| | specified keywords or hyperlinks |
| Schedule | Allows users to choose when the emails get sent |
| Recipients | For each email, users can set who they want to |
| | receive the email |

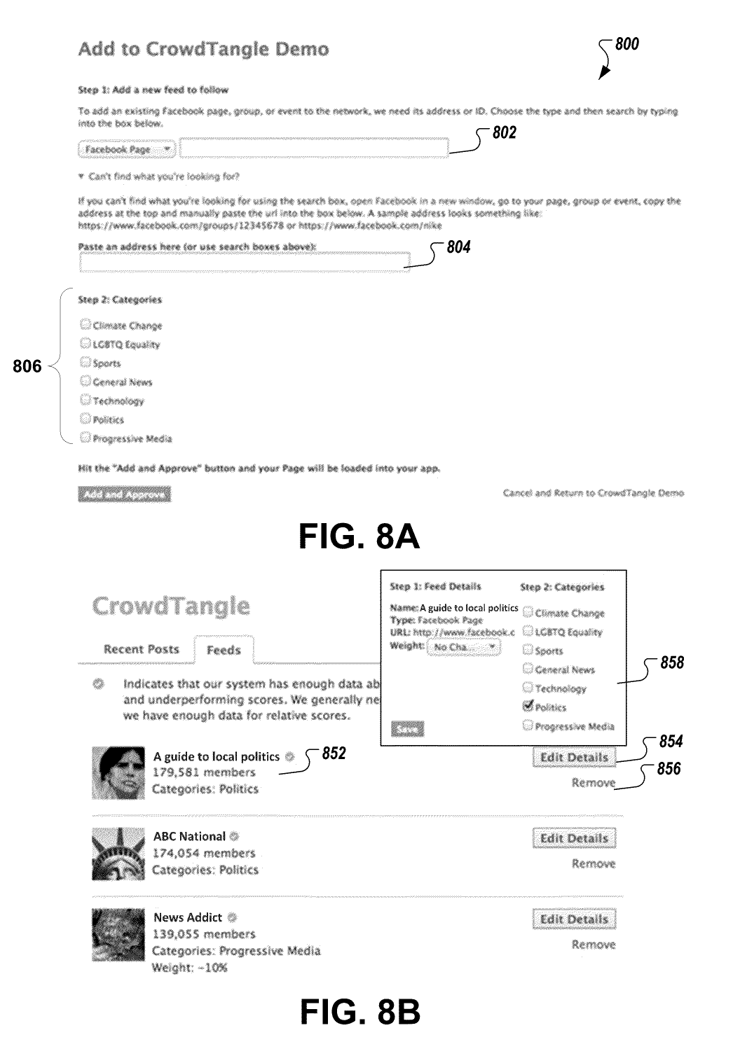

FIGS. 8A and 8B are diagrams of example GUIs 800 and 850 that are associated with, for example social network page management menus of a social post analysis application. FIG. 8A illustrates an example GUI 800 for selecting social network pages to be tracked by the social post analysis application. GUI 800 includes a social network page search textbox 802, a URL entry textbox 804, and social network page category selection controls 806. The social network page search textbox 802 allows a user to search for social network pages that they wish to track by entering keywords. The social post analysis application will search the electronic social networking platform for the pages based on the entered keywords and return a list of related social network pages. URL entry textbox 804 allows a user to directly enter the URL of a social network page that they wish to track. Once a user has selected a particular social network page to track (e.g., using either the search textbox 802 or the URL entry textbox 804), the category selection controls 806 allow the user to associate the selected social network page with one or more user defined categories.

FIG. 8A illustrates an example GUI 850 for managing selected social network pages tracked by a user's social post analysis application. GUI 850 includes a social network page summary 852, a social network page edit selection button 854, and a remove page link 856. Upon selection of the social network page edit selection button 854, the social post analysis application may provide the user with a popup dialog box 858 which allows the user to customize various settings related to the selected social network page. For example, a user may be permitted to alter the categories with which a page is associated. In some implementations, a user may be permitted to assign a rank to each page. The social post analysis application may then use the page rank to determine how often to display electronic message posts from the page within electronic message post feed 510. For example, the social post analysis application will display electronic message posts from a page with a higher rank more often than electronic message posts from a page with a lower rank. In some implementations the rank may include a page weighting which is incorporated with the performance score of each electronic message post generated from that page to determine the electronic message post's position within feed 510. For instance, the social post analysis application may increase the performance score of an electronic message post from a page by assigning the electronic message post a weight of +5, resulting in that electronic message post being posted in a more prominent position within the feed 510.

In addition to the features discussed above, some implementations of the social post analysis application may recommend posts to users that the users should repost on their own social network pages. Such implementations may provide a selection button alongside recommended electronic message posts to republish the content directly to the user's social network page. In some implementations, an electronic message post recommendation may be sent to the user via e-mail, and the e-mail may include a publish button.

Some implementations may automatically record the social network pages from which a user reposts an electronic message post and may track how well the reposted electronic message posts perform on the user's own social network page. In such implementations, the social post analysis application may create a “synchronicity” score to evaluate which social network pages have audiences that engage with the same type of content as the user's own social network page followers. The social post analysis application also may adaptively consider the “synchronicity” score to make better post recommendations.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, although various techniques generally are disclosed herein as being performed externally to an electronic social networking platform, in some implementations, the techniques disclosed herein may be performed internally by an electronic social networking platform.

1. A computer-implemented method of identifying trending content on a social networking platform comprising:
obtaining, at a server, a post from a source on a social networking platform, the post comprising content, a content type, and a time stamp;
determining, for the post, an engagement metric during each of a predetermined set of time periods;
generating, at the server, a representative engagement metric for a particular time period selected from the predetermined set of time periods, the representative engagement metric being based on the engagement metric of the post during the particular time period;
obtaining, at the server, a selected post from the source on the social networking platform;
transmitting, from the server, a score corresponding to a relative performance of the selected post compared to the representative engagement metric.

2. The method of claim 1, wherein the content type comprises one selected from the group consisting of images, hyperlinks, messages, videos.

3. The method of claim 1, wherein obtaining the post from the source on the social networking platform comprises obtaining a plurality of posts from the source on the social networking platform, each of the posts comprising content, a content type, and a time stamp,
wherein determining, for the post, an engagement metric during each of a predetermined set of time periods comprises determining, for each post, an engagement metric during each of a predetermined set of time periods, and
wherein generating the representative engagement metric for the particular time period selected from the predetermined set of time periods comprises generating the representative engagement metric for the particular time period selected from the predetermined set of time periods, the representative engagement metric being based on the engagement metrics of the plurality of posts during the particular time period.

4. The method of claim 3, wherein determining, for each post, an engagement metric during each of the predetermined set of time periods comprises determining, for each post, one or more of a number of likes, a number of shares, and a number of comments during each of a predetermined set of time periods.

5. The method of claim 3, wherein the representative engagement metric comprises an average engagement metric.

6. The method of claim 3, wherein the representative engagement metric comprises a weighted average engagement metric.

7. The method of claim 6, further comprising receiving, at the server, a set of weights for one or more of likes, shares, and comments; and
wherein generating, at the server, the representative engagement metric for the particular time period selected from the predetermined set of time periods, the representative engagement metric being based on the engagement metrics of the post during the particular time period comprises generating, at the server, a weighted average representative engagement metric for the particular time period selected from the predetermined set of time periods, the weighted average representative engagement metric being based on the engagement metrics of the post during the particular time period and the set of weights for one or more of likes, shares, and comments.

8. The method of claim 1, wherein the source comprises a page on the social networking platform.

9. The method of claim 1, further comprising:
determining that the score corresponding to the relative performance of the selected post compared to the representative engagement metric satisfies a predetermined threshold; and
transmitting, from the server, an alert identifying the selected post.

10. The method of claim 1, wherein obtaining, at the server, a selected post from the source on the social networking platform comprises receiving, at the server, a new post from the source on the social networking platform.

11. The method of claim 3, wherein generating, at the server, the representative engagement metric for the particular time period selected from the predetermined set of time periods, the representative engagement metric being based on the engagement metrics of the plurality of posts during the particular time period comprises generating, at the server, a representative engagement metric for a particular content type and a particular time period selected from the predetermined set of time periods, the representative engagement metric for the particular content type and the particular time period being based on the engagement metrics of the plurality of posts during the particular time period.

12. The method of claim 3, wherein generating, at the server, the representative engagement metric for the particular time period selected from the predetermined set of time periods, the representative engagement metric being based on the engagement metrics of the plurality of posts during the particular time period comprises generating, at the server, a representative engagement metric for each time period from the predetermined set of time periods, the representative engagement metrics being based on the engagement metrics of the plurality of posts during each respective time period.

13. A non-transitory computer-readable medium storing software comprising instructions executable by one or more computers which, upon such execution, cause the one or more computers to perform operations comprising:
obtaining, at a server, a post from a source on a social networking platform, the post comprising content, a content type, and a time stamp;
determining, for the post, an engagement metric during each of a predetermined set of time periods;
generating, at the server, a representative engagement metric for a particular time period selected from the predetermined set of time periods, the representative engagement metric being based on the engagement metric of the post during the particular time period;
obtaining, at the server, a selected post from the source on the social networking platform;
transmitting, from the server, a score corresponding to a relative performance of the selected post compared to the representative engagement metric.

14. The non-transitory computer-readable medium of claim 13, wherein the content type comprises one selected from the group consisting of images, hyperlinks, messages, videos.

15. The non-transitory computer-readable medium of claim 13, wherein obtaining the post from the source on the social networking platform comprises obtaining a plurality of posts from the source on the social networking platform, each of the posts comprising content, a content type, and a time stamp,
wherein determining, for the post, an engagement metric during each of a predetermined set of time periods comprises determining, for each post, an engagement metric during each of a predetermined set of time periods, and
wherein generating the representative engagement metric for the particular time period selected from the predetermined set of time periods comprises generating the representative engagement metric for the particular time period selected from the predetermined set of time periods, the representative engagement metric being based on the engagement metrics of the plurality of posts during the particular time period.

16. The non-transitory computer-readable medium of claim 15, wherein determining, for each post, an engagement metric during each of the predetermined set of time periods comprises determining, for each post, one or more of a number of likes, a number of shares, and a number of comments during each of a predetermined set of time periods.

17. The non-transitory computer-readable medium of claim 15, wherein the representative engagement metric comprises a weighted average engagement metric.

18. The non-transitory computer-readable medium of claim 13, further comprising:
determining that the score corresponding to the relative performance of the selected post compared to the representative engagement metric satisfies a predetermined threshold; and
transmitting, from the server, an alert identifying the selected post.

19. A system comprising:
one or more computers and one or more storage devices storing instructions that are operable, when executed by the one or more computers, to cause the one or more computers to perform operations comprising:
obtaining, at a server, a post from a source on a social networking platform, the post comprising content, a content type, and a time stamp;
determining, for the post, an engagement metric during each of a predetermined set of time periods;
generating, at the server, a representative engagement metric for a particular time period selected from the predetermined set of time periods, the representative engagement metric being based on the engagement metric of the post during the particular time period;
obtaining, at the server, a selected post from the source on the social networking platform;
transmitting, from the server, a score corresponding to a relative performance of the selected post compared to the representative engagement metric.

20. The system of claim 19, wherein the content type comprises one selected from the group consisting of images, hyperlinks, messages, videos.
